(19) United States
(12) Patent Application Publication
(10) Pub. No.: US 2015/0223024 A1
(43) Pub. Date: Aug. 6, 2015

(54) SYSTEM FOR AUTOMATICALLY MATCHING A SERVICE REQUESTOR WITH A SERVICE PROVIDER BASED ON THEIR PROXIMITY AND ESTABLISHING A VOICE CALL BETWEEN THEM

(71) Applicant: Sa'ad Abuodeh, Toronto (CA)

(72) Inventor: Sa'ad Abuodeh, Toronto (CA)

(73) Assignee: STONETHROW TELECOMMUNICATIONS LTD., Tortola (VG)

(21) Appl. No.: 14/420,531

(22) PCT Filed: Aug. 7, 2012
(86) PCT No.: PCT/CA2012/050537

§ 371 Date: Feb. 9, 2015

(51) Int. Cl. H04W 4/02; H04W 74/06

(52) U.S. Cl. CPC H04W 4/023; H04W 74/06

(57) ABSTRACT

A system for automatically matching a service requestor with a service provider based on their physical proximity to each other. A client requesting a service (e.g. Taxi service) using a cellular telephone calls an automatic server. The server interfaces with the cellular operator(s) systems and acquires the client's location. The server also regularly keeps track of the locations and availability of pre-registered service providers (e.g. Taxi Cabs) through the same interface with the cellular operator(s). The server then matches the service requestor with a service provider based on the physical proximity of the latter to the former through a matching algorithm. Once the matching is performed, the server establishes a voice call where the service requestor is the call originator (A-Party) and the service provider is the call recipient (B-Party) so both parties can verbally agree on the details of their transaction.

### BACKGROUND

1. Technical Field

The embodiments herein generally relate to telecommunications, and, more particularly, to a telecommunications system that matches a service requestor carrying a mobile telephone with a service provider also carrying a mobile telephone, based on the closest physical proximity of the two said mobile telephones.

2. Description of the Related Art

The problem with today's typical methods for matching a service requestor with a service provider (e.g. Taxi client with a Taxi driver) is wrought with inconvenience, cost, and a relatively big carbon footprint. The different methods include the more classic method where a client has to walk to the nearest main street, wait around for a marked taxi to pass by and then hail it hoping that it is available to pick him up. For the client, there is unnecessary time wasted, unnecessary effort made as well as being subjected to the weather at the time be it rain, snow, wind, cold, heat, or humidity. For the taxi itself, typically the driver always feels compelled to keep roaming the streets looking for clients before another taxi “wins” the client's business first. This roaming wastes fuel, subjects the taxi driver to potential yet unnecessary car accident risks, which are especially heightened as the taxi driver would be more focused on the sidewalks looking for customers rather than the roads where the traffic dangers exist. Moreover, the sudden lane changes or sudden stops by taxi drivers when they locate a potential client on the curb can lead to tension on the roads for other drivers, which manifest themselves as unnecessary congestions, accidents, noise pollution, and perhaps fights.

The carbon footprint associated with this method is relatively high since the taxis roam the streets in large numbers wasting fuel unnecessarily and contributing to traffic jams. If we scale this carbon footprint globally, we will find out that such method is contributing a sizeable amount of greenhouse gas (GHG) and is exacerbating the world's environmental problems.

Other methods include calling a taxi service company which requests detailed address information before deploying one of the taxis in their own fleet. Typically, such fleets are small and limited to the number of cars of that particular company. The dispatcher of that company will request the nearest car to be deployed to the client, however, due to the fact that the number of cars is relatively small and is not capable of thoroughly covering a typical city and its suburbs, the “nearest” car will end up, or very likely risk, making a sizeable trip to the location of the client thus wasting time and fuel and also contributing to traffic jams and adding to the carbon footprint of the service. Some companies use GPS location finding, some use fleet management systems for their fleet but regardless of the technology, a trip has to be made by the nearest car to the client and this could take several miles and even more minutes, especially at times of traffic congestion. The client will be inconvenienced by the time wasted in giving the address, waiting for the taxi to arrive and sometimes he/she ends up waiting for a long time outside the address until the taxi arrives and will be subjected to the weather conditions. Even with this method, the taxi company/driver will still suffer from unnecessary fuel consumption, the city will suffer from the unnecessary addition to its traffic jams, and the carbon footprint will be unnecessarily larger.

The extreme proliferation of mobile phones in all segments of the society including both clients and taxi drivers, presents an appropriate “infrastructure” that can be leveraged to solve the above problem by minimizing the inconvenience, the cost and the associated carbon footprint thus giving benefit to all stakeholders in this system. However, if such a system is to succeed globally and change the classic methods of hailing taxis and/or using a dispatch; thus removing all the negativities associated with such systems. The system should have the following characteristics:

It should have no entry barriers including extra hardware or software at either the service requestor's or the service provider's side. It should not require any special training for usage by neither the service's requestor nor its provider. It should not be limited to a particular fleet of taxis or any specific taxi company. It should be fully automated and should not require any human intervention or any dispatcher. It should be simple and not over-engineered leveraging the voice service in mobile telephones as it is the service used by all masses everywhere.

### SUMMARY

In view of the foregoing, an embodiment herein provides a system(s) which is (are) connected to each of the mobile operators in a city/country. The service will advertise, utilizing all different advertising methods, a pre-determined chargeable short code/number which can be dialed by any service requestor (“Client”) using his mobile telephone whenever and wherever s/he requires the service. The system will detect the Client's location using not only the available location technologies with the mobile operator including Cell-ID, Triangulation or GPS (or Assisted-GPS), but is also engineered to accommodate future Location Determining technologies that may supersede existing ones. Such location information will be compared against the locations of pre-registered available service providers (“Taxi drivers”) in order to efficiently match a Taxi driver, according to the physical proximity of the Client. Such matching is subjected to other programmable considerations including prioritizing Taxis who have a better satisfaction record than others, prioritizing same-mobile-operator Taxis and/or deprioritizing Taxis who have received more matches than others. The matching will manifest itself in a voice connection between the Client and the matched Taxi, where they can verbally communicate so the former can describe to the latter his/her location so the service delivery/pick-up can be successful. The physical proximity nature of the service dictates that the Client and the matched Taxi are within a short distance of each other and accordingly, the pick-up will occur in a very short period of time.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a block diagram of a system according to an embodiment herein;

FIG. 2 illustrates a block diagram of a centralized system according to an embodiment herein;

FIG. 3 illustrates a block diagram of a distributed system according to an embodiment herein;

FIG. 4 illustrates a block diagram of a system according to another embodiment herein;

FIG. 5 illustrates a Mobile Proximity Matching Service “MPMS” service process flow diagram according to an embodiment herein;

FIG. 6 is a flow diagram illustrating a call back process according to an embodiment herein;

FIG. 7 is a flow diagram illustrating a driver's registration process according to an embodiment herein;

FIG. 8 is a flow diagram illustrating an on-duty/off-duty toggle process according to an embodiment herein;

FIG. 9 is a flow diagram illustrating a driver's dynamic interactive voice response (IVR) system logic process according to an embodiment herein;

FIG. 10 is a flow diagram illustrating a client's dynamic IVR logic process according to an embodiment herein; and

FIG. 11 is a block diagram illustrating a computer system according to an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

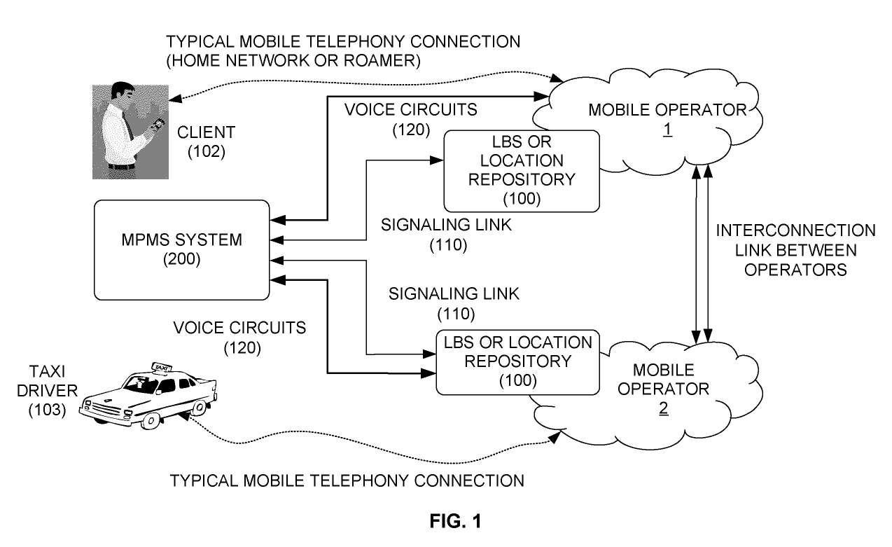

Referring now to the drawings, and more particularly to FIGS. 1 through 11, where similar reference characters denote corresponding features consistently throughout the figures, preferred embodiments are described herein.

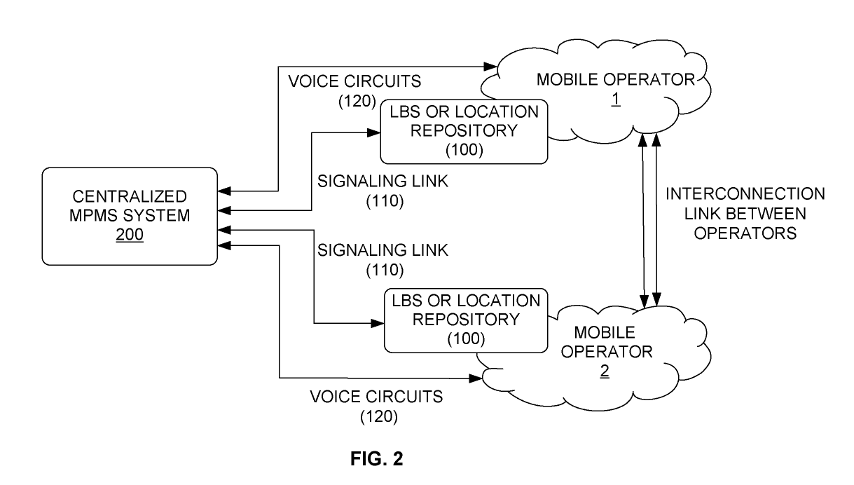

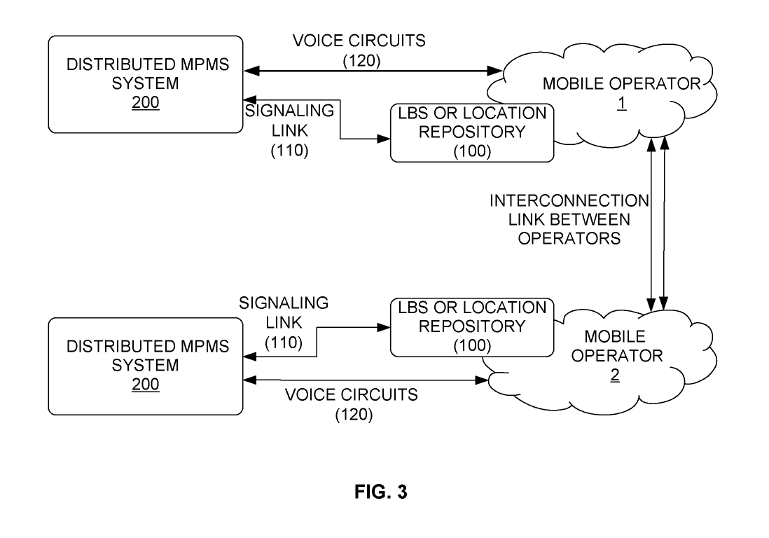

FIG. 1 describes the system topology, where FIG. 2 describes one possible topology and FIG. 3 describes another possible topology of the MPMS system's location vis-à-vis the mobile operator(s). The MPMS system 200 is connected to each mobile operator by virtue of a data connection 110 that is connected with each operator's Location Based Server (“LBS”) if available or to the repository of location updates (“Locations Repository” 100). The MPMS system 200 is also connected with each operator via voice circuits 120, the dimensioning of which is based on a forecast pre-agreed with each operator and upgraded as the service evolves.

Clients 102 are connected through a typical cellular connection that is provided by their home operator. In FIG. 1, it appears that the Client is connected to Mobile Operator 1, but he can be connected to any mobile operator and he can even be a roamer. Similarly, the taxi driver 103 appears to be connected to Mobile Operator 2, but in reality he can be connected to any mobile operator.

The Clients 102 and the Taxi drivers' 103 connections with their respective mobile operators 1, 2 are typical voice-only or voice/data subscriptions with no special hardware or software or special subscription. The only service required to be operational in such telephones is the voice service. Having the short message service (SMS) is an added bonus.

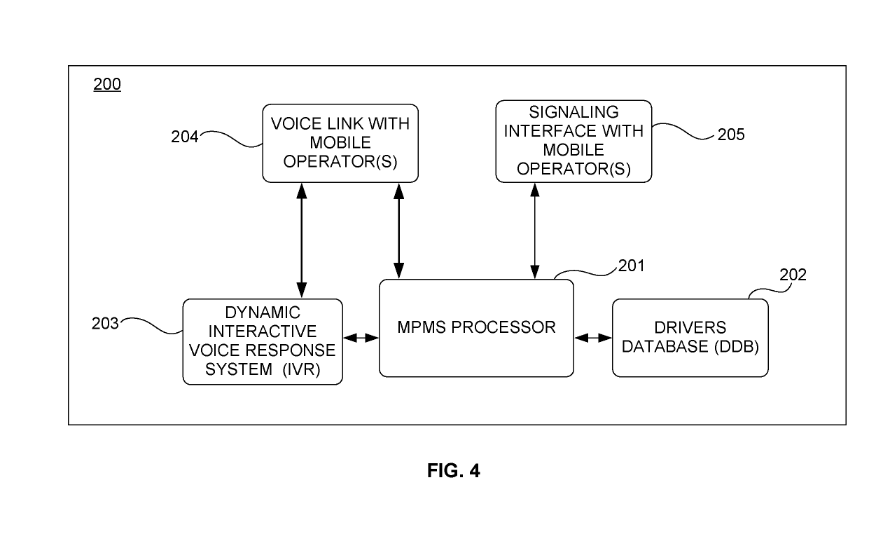

FIG. 4 describes the typical topology of the MPMS system 200. The MPMS system 200 comprises a Drivers Data-Base (“DDB”) 202 which is continuously being updated by the system to include the following information:

Drivers Registry including the drivers MSISDN numbers, names and any other information required by each country's regulatory or security departments which may vary from one country/city to another. However, the MSISDN number is required by the service as a minimum, and this piece of information is retrieved from the Caller Line Identification (CLI) information automatically generated by the Driver's telephone call when he first calls to register himself as a “Registered Driver”.

Location information of the drivers 103, which intermittently gets refreshed based on a pre-agreed algorithm with each mobile operator 1, 2. This geographical information is mapped against the location updates automatically and regularly generated by the mobile operator systems 1, 2. This information gets refreshed furthermore selectively based on re-polling the mobile operator systems once a client 102 dials for the service.

An On-Duty/Off-Duty marker is controlled by the driver 103 himself to indicate whether he is working or not. An Available/Busy marker is generated by the system 200 in three cases:

First, when the driver 103 is matched with a client 102, the marker is turned to “Busy” in order to avoid assigning matches to this driver 103 while he is already busy with the one he just got matched to. Second, when the driver 103 does a “Call Rejection” on his mobile handset when a match has been assigned to him. This indicates that he is already busy with a client 102 that he probably picked up from the street and accordingly the system 200 will interpret the “Call rejection” as such. Third, if the driver 103 does not answer his mobile handset in a configurable number of rings when a match is assigned to him. This also indicates that he is already busy with another client and accordingly the system 200 will interpret the “No answer” as such. In both cases, the system 200 will re-mark the driver as “Available” after a configurable number of minutes based on his location and the time-of-day.

The Driver Satisfaction Score which is based on an accumulation of the driver's individual history of complaints, satisfaction scores, etc.

The MPMS system 200 also comprises a dynamic Interactive Voice Response system (IVR) 203 which controls the interaction with the drivers 103 and the clients 102 according to a pre-set logic.

The MPMS system 200 also comprises signaling port(s) 205 that are connected with each mobile operator through the signaling links 110. Such links utilize data connectivity protocols to pass control signals between the MPMS system 200 and the mobile operator(s) systems 1, 2 for the MPMS 200 to operate as described herein.

The MPMS system 200 also comprises voice ports 204 that connect the MPMS system 200 with each mobile operator 1, 2 through the voice circuits 120. Such voice circuits can either be E1's or equivalent or a multiple thereof. Such links enable the routing of voice traffic between the clients 102 and the taxi drivers 103 between operators 1, 2. These links also allow voice traffic and DTMF tones to allow the clients 102 and the taxi drivers 103 to make selections on the dynamic IVR system 203.

The MPMS system 200 also comprises a processor 201; wherein the MPMS processor 201 comprises a computer or a server that controls the operation of the MPMS service as described herein. More specifically, the processor 201 controls the matching algorithm between the clients 102 and the taxi drivers 103, the fetching of location information from the mobile operators' systems 1, 2, the dynamic IVR operation, the update of DDB in addition to all typical server functions.

FIG. 2 describes one possible topology of the MPMS system 200. This topology is described as the Centralized Model where there will be only one MPMS system 200 in each country/city connected to all the operators in that country/city. In this model, the MPMS system 200 is connected to each operator 1, 2 by virtue of a data connection 110 that is connected with each operator's Location Based Server (“LBS”) or to the repository of location updates (“Locations Repository” 100). The MPMS system 200 is also connected with each operator 1, 2 via voice channels 120 dimensioned based on a forecast pre-agreed with each operator 1, 2 and upgraded as the business evolves.

FIG. 3 describes another possible topology of the MPMS system 200. This topology is described as the Distributed Model where there will be an MPMS system 200 residing at the premises of each mobile operator 1, 2 in a country/city. In this model, each MPMS system 200 is connected to each operator 1, 2 by virtue of an on-premise data connection 110 that is connected with each operator's Location based Server (“LBS”) or to the repository of location updates (“Locations repository” 100). The MPMS system 200 is also connected with each operator 1, 2 via on-premise voice channels 120 by cable or optical fiber. The distributed MPMS systems in the city/country are then connected to each other via different methodologies such as database mirroring so that they all behave as one whole integrated system.

In both the Centralized Model and the Distributed Model (FIGS. 2 and 3, respectively), the MPMS system 200 will be comprised of the same components as described in FIG. 4. In FIGS. 1 through 3, the mobile operators 1, 2 are already connected to each other via interconnection links. Also, although the figures indicate that there are only two mobile operators 1, 2; the same applies for more than two operators and up to the number of mobile operators 1, 2 in such country/city.

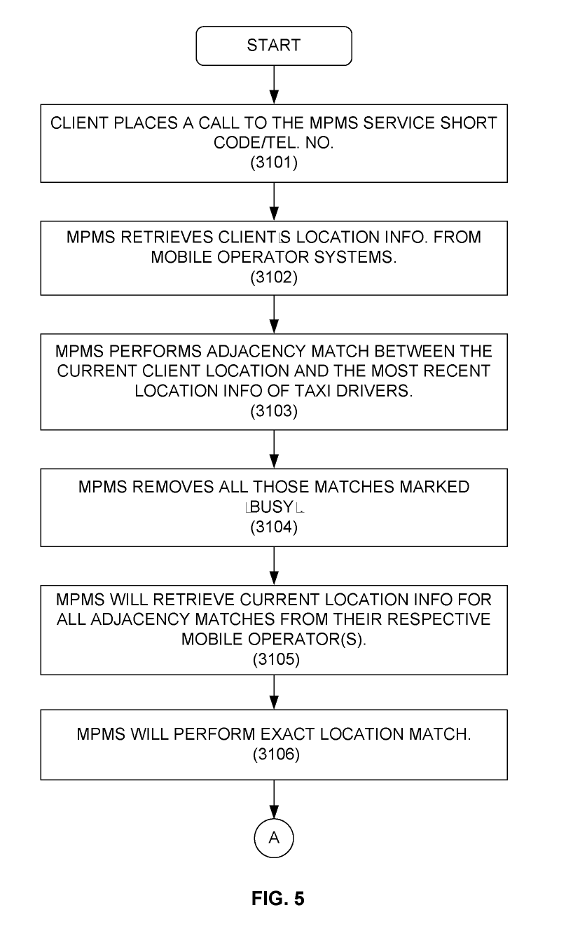

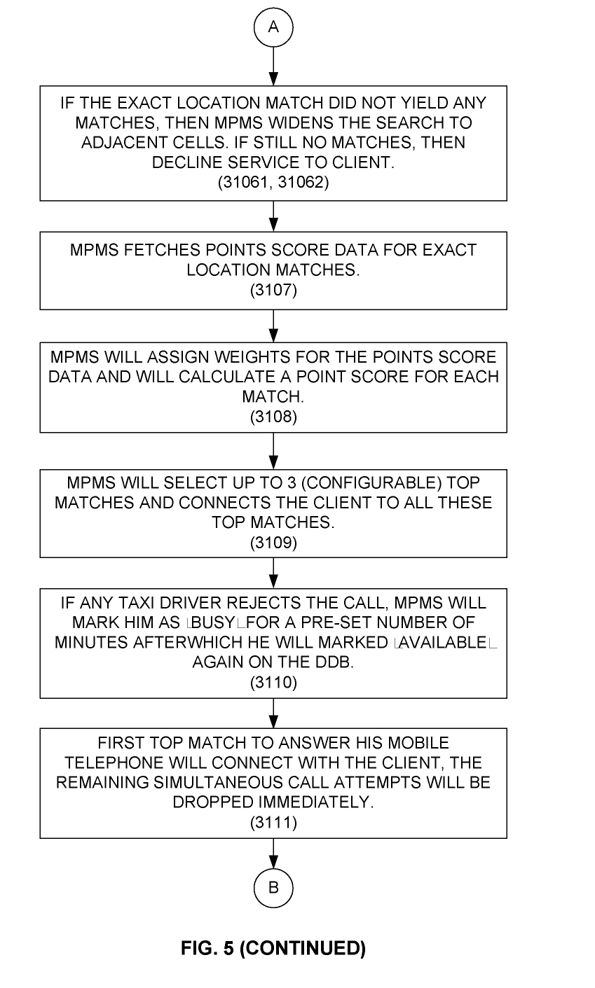

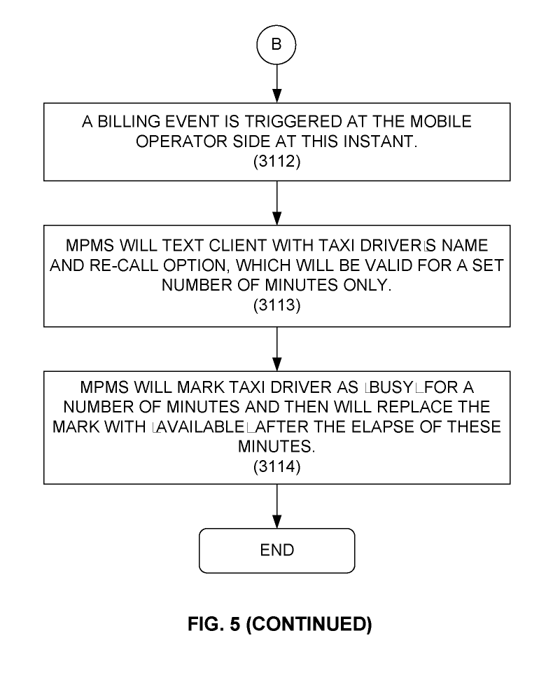

FIGS. 5 through 8, with reference to FIGS. 1 through 4, are flowcharts that describe the operation of the MPMS service. FIG. 5 describes the operation of the client-initiated call for the MPMS service. In step (3101), the client 102 places a call on the service short code/number (e.g. 1234) thus requesting to be connected to a nearby taxi driver 103 who is on-duty and available to pick him up. In step (3102) The MPMS system 200 will immediately retrieve the client's CLI information (i.e. MSISDN number) and will fetch his location information from his home mobile operator 1, 2 through the signaling links 110. The voice channel of this call will be momentarily reserved until a match is found.

The MPMS system 200 will match the client 102 with the best nearby taxi driver 103 according to the following logic:

In step (3103), the MPMS system 200 will find the best matches based on the last location update that is already stored in the DDB 202. In this instance the location of the client 102 is matched with the location of the taxi driver 103 in his current geographic location as captured in the DDB 202 in addition to matches with taxi drivers in adjacent geographic locations and next-to-adjacent geographic location since the taxi drivers 103 may have moved closer from adjacent locations to the client's current location since the last location update. The matching will take into consideration the location (e.g. downtown, suburban, or rural etc.) and the time-of-day (e.g. peak traffic or off-peak traffic) and the number of registered taxi drivers 103 in the client's cell in order to determine to what level of adjacency the matching needs to be done. This match is referred to as the (“Adjacency Match”), which is a preliminary step and is based on location information that is not real-time (current).

In step (3104), the MPMS system 200 will eliminate all those matches from the Adjacency Match above who have a “Busy” mark in the DDB 202. In step (3105), the MPMS system 200 will then fetch from the mobile operator(s) 1, 2 all the current location information of those taxi drivers 103 matched with the client 102 in the Adjacency Match who are not “Busy” and update the DDB 202 accordingly.

In step (3106), the MPMS system 200 will then perform an “Exact Cell Match” only on those taxi drivers 103 that have been filtered in step (3104) above. All of those taxi drivers 103 that do not match will be eliminated for this case only.

In step (31061), if the “Exact Cell Match” above yields no matches at all, the MPMS system 200 will widen its match and conduct an “Exact Adjacent Cells Match”, which will basically widen the geographical area of the match to include the adjacent cells. This match will only use the data yielded by the step (3105) above, which is based on the current real-time locations of the cars yielded by the “Adjacency Match” in step (3103).

In step (31062), if the “Exact Adjacent Cells Match” still yields no matches, the MPMS system 200 will play an IVR recording to the client 102 apologizing for not being able to find him a match and asks him to try again in a short period of time.

In step (3107), the MPMS system 200 will retrieve the Drivers Satisfaction Scores from the DDB 202 for the matches yielded by steps (3106 or 31061), as well as the number of matches they have been assigned in the past configurable number of hours/days and the mobile operator 1, 2 the taxi driver 103 is subscribed to and the mobile operator 1, 2 the client 102 is subscribed to. This data is referred to as the “Points Score Data”, and may include other elements.

In step (3108), the MPMS system 200 will then apply a points score for all these drivers 103 according to the following weighting criteria:

Proximity will be given a certain configurable weight.

The taxi driver 103 being a subscriber of the same mobile operator 1, 2 as the client 102 will be given a certain configurable weight.

The taxi driver 103 not having been selected for a match or more for a certain configurable number of hours/days will be given a certain configurable weight.

The driver's satisfaction score of each driver 103 will be given a certain configurable weight.

All the above factors will be applied to a weighting formula that calculates a final score for each of the remaining matched taxi drivers 103.

The MPMS system 200 will then select the Top Matches according to their final scores (number of Top Matches is configurable, say 3 matches as an example) and if there are less than 3 matches, all such matches will be selected as Top Matches.

In step (3109), the MPMS system 200 will then connect to all Top Matches to the client 102 simultaneously. All telephones will ring simultaneously. In another embodiment, the MPMS system 200 will contact the first of the Top Matches first, and if he does not answer within a pre-set number of rings, the MPMS system 200 will connect the client 102 to the second match and disconnects the first match and makes him “Unavailable” on the DDB 202 and so on thus achieving sequential calling of top Matches rather than simultaneous calling.

In step (3110), if any of the taxi drivers 103 rejects the call by pressing the reject button on his mobile telephone, the MPMS system 200 will immediately connect the client 102 to the next Top Match. Additionally, the MPMS system 200 will update the DDB 202 and mark this taxi driver 103 who rejected the call as “Busy” for a configurable number of minutes, after the elapse of which he will be marked “Available” again.

In step (3111), the first taxi driver 103 to answer his mobile telephone will be connected to the client 102 and the remaining simultaneous Top matches will be disregarded.

In step (3112), the mobile operator 1, 2 will bill this call and divide its revenues with the MPMS system 200 based on a pre-agreed agreement between the mobile operator 1, 2 and the MPMS service.

In step (3113), the MPMS system 200 will automatically send a SMS to the client 102 with the name of the taxi driver 103 as stored in the DDB 202. This SMS will also contain an instruction to the client 102 stating that, if he wishes to re-contact the same taxi driver 103, he could re-dial the short code/number again within a configurable number of minutes and he could also rate that driver 103.

The MPMS system 200 will then start a counter for the same number of configurable minutes as in step (3113) above and if the same client 102 dials the short code/number, he will be given the choice to either be connected directly to the same matched taxi driver 103, or be matched with another taxi driver 103 or to rate the same driver 103.

In step (3114), the MPMS system 200 will update the DDB 202 by marking the taxi driver 103 in step (3111) “Busy” for a configurable number of minutes. This number of minutes will also depend on the geographic location and the time-of-day. The MPMS system 200 will start a counter for that number of minutes. In step (3114), once the counter runs to zero, the taxi driver 103 status will be marked “Available” again.

The MPMS 200 will use the Mobile Operator's designs as a proxy for geographic location and time-of-day. More specifically, the cell sizes as designed by the operator(s) 1, 2 will be a proxy for the level of urbanism the location is at, where small cell sizes will correspond to more urban locations and larger cell sizes will correspond to more rural or highway locations. As for time-of-day, the cellular voice traffic behavior will be adopted as proxy for time-of-day calculations where higher voice cellular traffic will be considered as a proxy for high car traffic and vice versa.

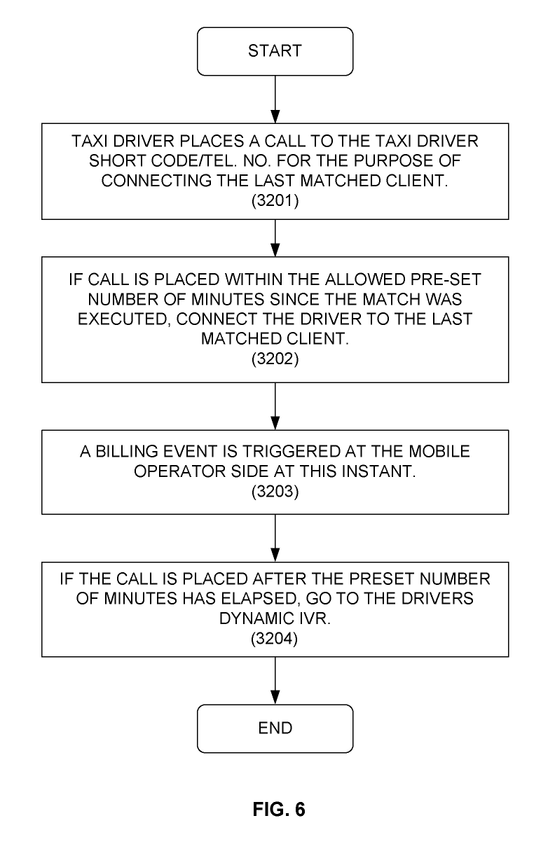

FIG. 6, with reference to FIGS. 1 through 5, describes the operation of the taxi driver-initiated client call-back process. In step (3201), a registered taxi driver 103 who has just been matched by the MPMS system 200 to a client 102 will dial the driver's short code/telephone number within a configurable number of minutes typically for the purpose of re-contacting the client 102 he was just matched to for the purpose of getting more accurate directions to pick up the client 102. The MPMS system 200 will respond through the IVR system 201 and one of the options presented to him will be to re-contact the last client 102. In step (3202), if the taxi driver 103 makes this selection, the MPMS system 200 will reconnect him with the same client 103 and in step (3203), the mobile operator 1, 2 will bill this call and divide its revenues with the MPMS Service based on a pre-agreed agreement between the mobile operator 1, 2 and the MPMS service.

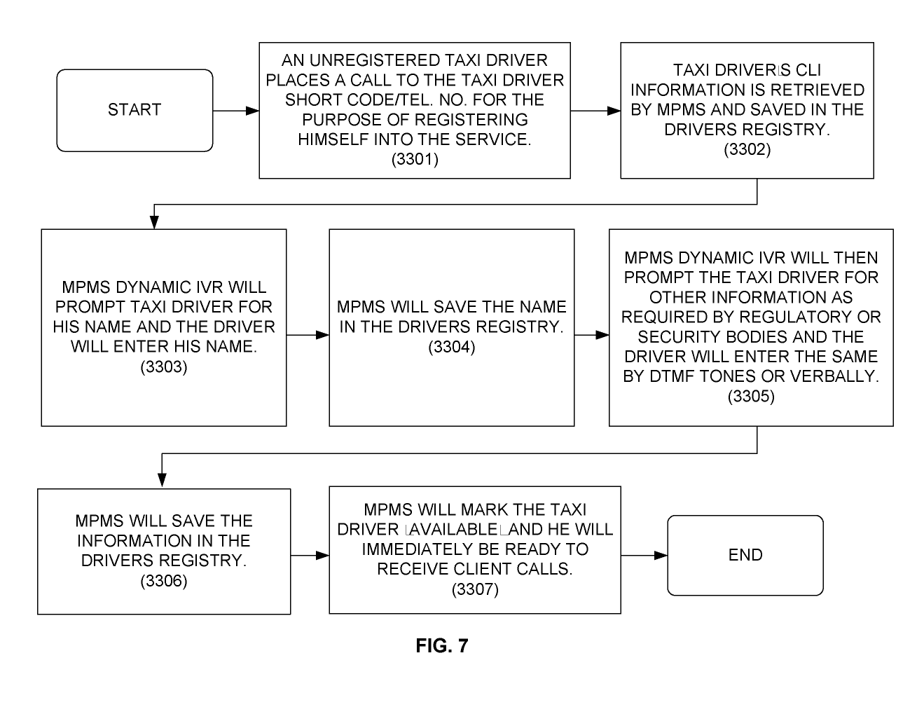

FIG. 7, with reference to FIGS. 1 through 6, describes the operation of the taxi drivers-initiated registration process. In step (3301), an unregistered taxi driver 103, driven by classical and mobile advertisement or by word-of-mouth will call the driver's short code/telephone number for the purpose of registering himself to the MPMS service. In step (3302), the MPMS system 200 will first retrieve the driver's 103 CLI information and store the driver's 103 number in DDB 202, and then in step (3303) respond through the dynamic IVR 201 which will prompt the driver 103 to give his name verbally which will be recorded and later transcribed into text manually and stored in DDB 202. In step (3304), the newly registered taxi driver 103 will immediately be marked “On-Duty” and “Available” and the DDB 202 will be updated accordingly. In step (3305), the driver 103 will also be prompted for any other information that is required by any regulatory or security body of the respective country/city and the DDB 202 will be updated accordingly.

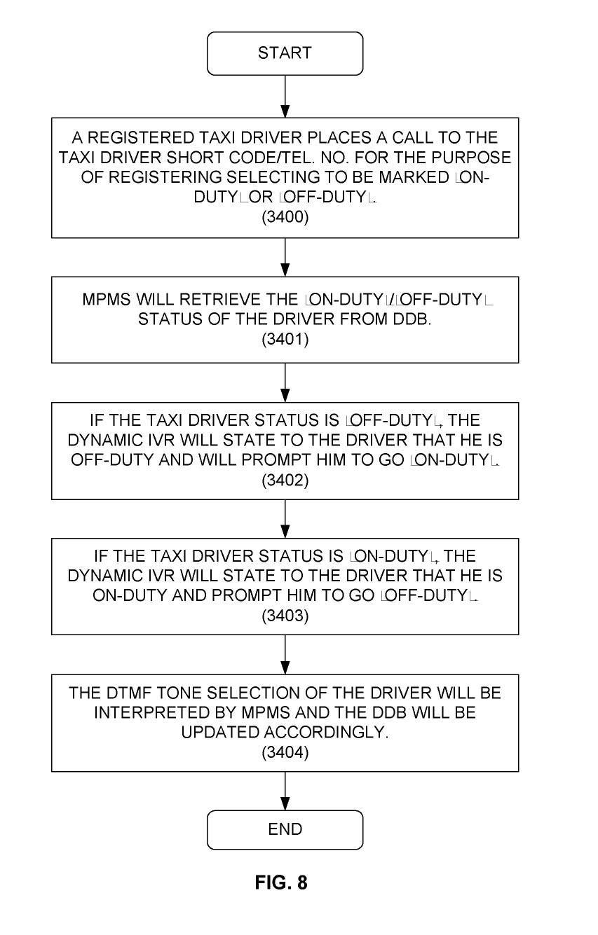

FIG. 8, with reference to FIGS. 1 through 7, describes the operation of the taxi driver-initiated “On-Duty”/“Off-Duty” toggle process. In step (3401), a pre-registered taxi driver 103 will call the driver's short code/telephone number and the MPMS system 200 will respond through the dynamic IVR 201 by presenting him with the option in step (3402) to go “On-Duty” if his status on the DDB 202 is “Off-Duty” and will present him the option in step (3403) to go “Off-Duty” if his status on the DDB 202 is “On-Duty”. The driver 103 makes that selection by pressing the corresponding number of his choice on his mobile telephones keypad which sends an instruction via DTMF tone to the IVR 201. In step (3404), the MPMS 200 will update the DDB 202 according to his choice.

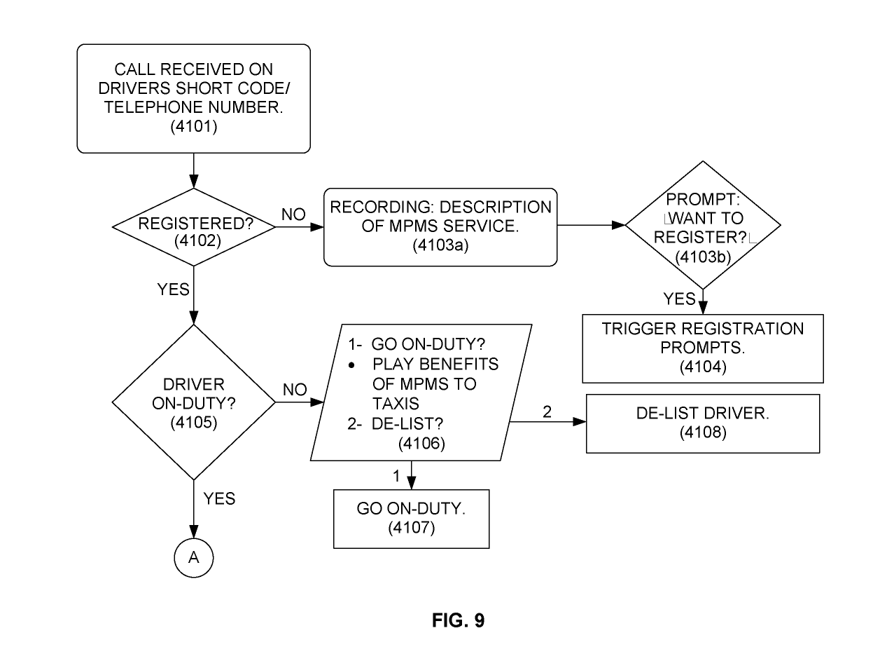

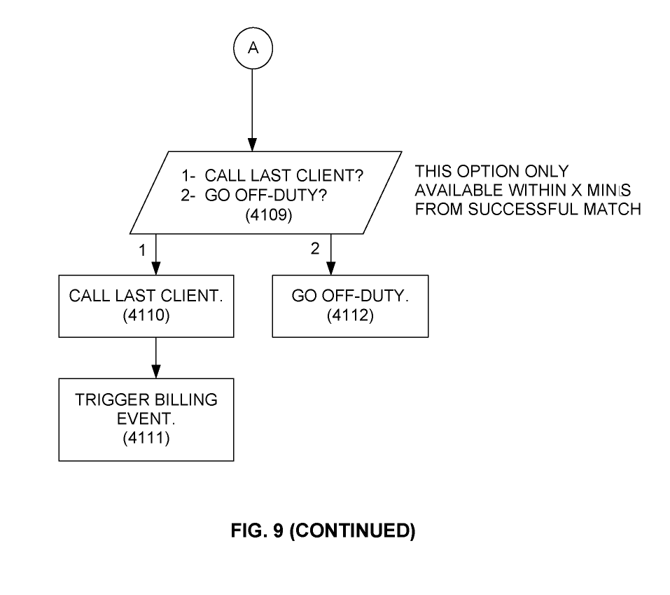

FIG. 9, with reference to FIGS. 1 through 8, depicts an exemplary method for the utilization of the dynamic IVR system 201 which is used by the taxi drivers 103. In step (4101), once the taxi driver 103 calls the driver's short code/telephone number, in step (4102), the MPMS 200 will automatically check if his number is already registered. If the number is not registered, in step (4103), a recording describing the service will be played and afterwards the taxi driver 103 will be prompted to accept to be registered or not. If the driver 103 agrees, in step (4104), the registration process begins by prompting the required information from the driver 103 and the DDB 202 will be updated immediately.

If the driver 103 is already registered, in step (4105), the MPMS 200 will automatically check if his “On-Duty/Off-Duty” status is “On-Duty”. If it is not, in step (4106), the taxi driver 103 will be prompted to accept to be placed “On-Duty” and if he agrees, in step (4107), the MPMS 200 will update the DDB 202 accordingly. If the driver 103 doesn't accept to be “On-Duty”, another recording will be played to stress the benefits of the MPMS service to taxi drivers 103 and the taxi driver 103 will be prompted to unregister himself. If the driver 103 agrees, in step (4108), he will be de-listed from the DDB 202 altogether and he will cease to be listed as a taxi driver 103.

Finally, in step (4109), if the driver 103 is “On-Duty” he will be given the choice to either contact the last matched client and this option will only be available for a configurable number of minutes (x minutes) and if he agrees, in step (4110), the driver 103 will be connected with the last matched client 102 and in step (4111), the call will trigger a billing event. The second choice will be for the driver 103 to go “Off-Duty”, which if he agrees to, in step (4112), he will be marked as “Off-Duty” in the DDB 202.

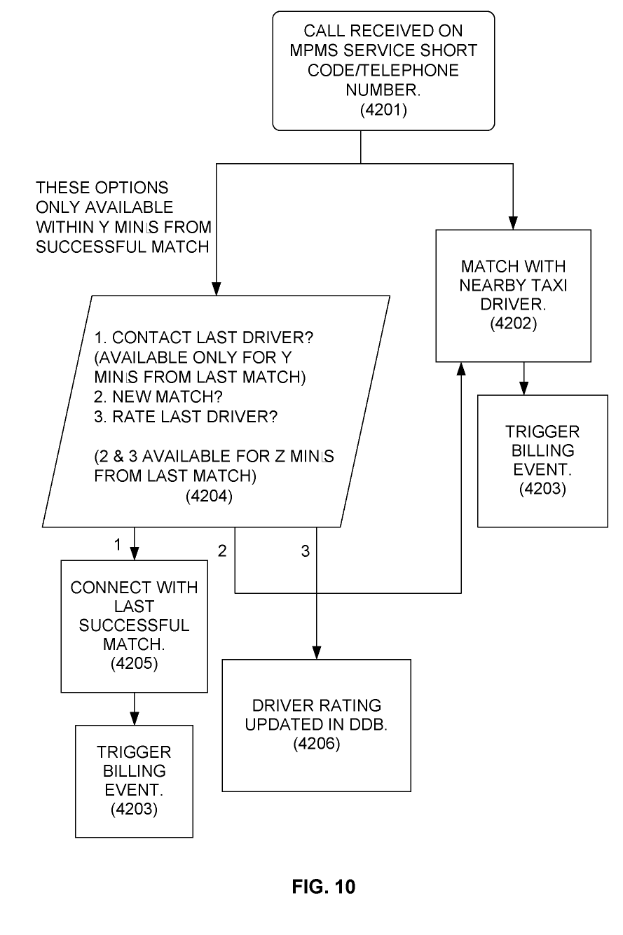

FIG. 10, with reference to FIGS. 1 through 9, depicts an exemplary method for the utilization of the dynamic IVR system 201 which is used by clients 102. In step (4201), once a client 102 calls the MPMS service short code/telephone number, in step (4202), the MPMS system 200 will automatically match him with a nearby taxi driver 103, and in step (4203), a billing event will be triggered at the mobile operator 1, 2. In step (4204), two other choices are selectively presented based on the time elapsed since the last successful match.

The first choice will be presented only within y minutes from the last match (typically 10-20 minutes) and this choice will give the client 102 the ability to contact the taxi driver 103 of his last successful match. The purpose of this option is to check on the taxi driver 103 if he is delayed or if the verbal direction given were inaccurate. In step (4205), if the client 102 selects this choice, he will be connected to the last matched taxi driver 103 and in step (4203), a billing event will be triggered.

The second choice will be presented within y minutes from the last successful match (typically 1-2 hours) and this choice will give the client 102 the ability to rate the level of service received from the last taxi driver 103 of the last successful match. In step (4206), if the client 102 selects this choice, he will be asked by the IVR 201 to enter a number corresponding to his level of satisfaction.

As long as any of the two above choices is given by the dynamic IVR system 201, the IVR 201 will also deliver the option to match with a new taxi driver 103 so as to maintain this possibility for the client 102 at any time.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein include both hardware and software elements. The embodiments that are implemented in software include but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and wired/wireless Ethernet cards are just a few of the currently available types of network adapters.

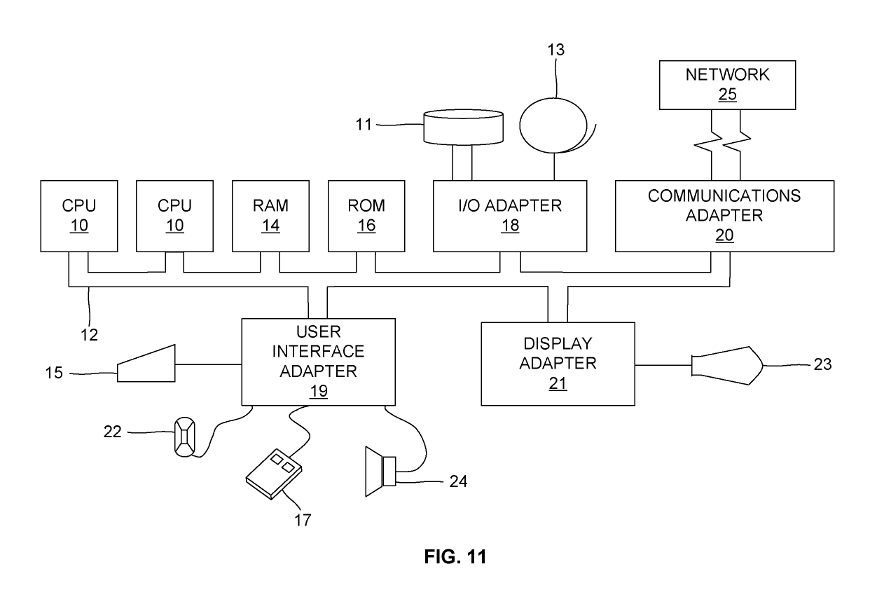

A representative hardware environment for practicing the embodiments herein is depicted in FIG. 11. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

1. A method comprising:
matching a service requestor having a first mobile telephone with a service provider having a second mobile telephone;
automatically establishing a voice connection between said service requestor and said service provider;
retrieving location information for pre-registered service providers from mobile operators and storing said location information in a database; and
retrieving a location of a service requestor upon a request by said service requestor for service in real time and matching said service requestor with a nearby suitable service provider based on any of:
a pre-set criteria of re-polled real-time location information,
a prior performance, and
a fairness protocol according to a flexible weighting formula to create a prioritized list of best matches.

2. The method in claim 1, wherein said service requestor comprises a client.

3. The method in claim 1, wherein said service provider comprises a taxi driver.

4. The method in claim 1, further comprising connecting said service requestor and said service provider with said mobile operators.

5. The method in claim 1, further comprising matching a service requestor with a service provider based on a proximity between said service requestor and said service provider to each other.

6. The method of claim 5, further comprising searching for wide potential matches from adjacent and next- to-adjacent and next-to-next-to-adjacent cells based on non-real-time data, re-polling of said mobile operators for real-time locations, and performing a final narrow match on the re-polled location information.

7. The method in claim 1, further comprising simultaneously or sequentially connecting multiple service providers to said service requestor and allowing the first service provider to answer to connect with said service requestor.

8. The method in claim 1, further comprising establishing a voice connection upon a successful match between said service requestor and said service provider.

9. A non-transitory program storage device readable by computer, and comprising a program of instructions executable by said computer to perform a method, said method comprising:
matching a service requestor having a first mobile telephone with a service provider having a second mobile telephone;
automatically establishing a voice connection between said service requestor and said service provider;
retrieving location information for pre-registered service providers from mobile operators and storing said location information in a database; and
retrieving a location of a service requestor upon a request by said service requestor for service in real time and matching said service requestor with a nearby suitable service provider based on any of:
a pre-set criteria of re-polled real-time location information,
a prior performance, and
a fairness protocol according to a flexible weighting formula to create a prioritized list of best matches.

10. The program storage device in claim 9, wherein said service requestor comprises a client.

11. The program storage device in claim 9, wherein said method further comprises connecting said service requestor and said service provider with said mobile operators.

12. The program storage device in claim 9, wherein said method further comprises matching a service requestor with a service provider based on a proximity between said service requestor and said service provider to each other.

13. The program storage device of claim 12, wherein said method further comprises searching for wide potential matches from adjacent and next- to-adjacent and next-to-next-to-adjacent cells based on non-real-time data, re-polling of said mobile operators for realtime locations, and performing a final narrow match on the re-polled location information.

14. The program storage device in claim 9, wherein said method further comprises simultaneously or sequentially connecting multiple service providers to said service requestor and allowing the first service provider to answer to connect with said service requestor.

15. The program storage device in claim 9, wherein said method further comprises establishing a voice connection upon a successful match between said service requestor and said service provider.

16. A mobile proximity matching service system comprising:
means for matching a service requestor having a first mobile telephone with a service provider having a second mobile telephone;
means for automatically establishing a voice connection between said service requestor and said service provider;
means for retrieving location information for pre-registered service providers from mobile operators and storing said location information in a database; and
means for retrieving a location of a service requestor upon a request by said service requestor for service in real time and matching said service requestor with a nearby suitable service provider based on any of:
a pre-set criteria of re-polled real-time location information,
a prior performance, and
a fairness protocol according to a flexible weighting formula to create a prioritized list of best matches.

17. The system in claim 16, further comprising means for connecting said service requestor and said service provider with said mobile operators.

18. The system in claim 16, further comprising:
means for matching a service requestor with a service provider based on a proximity between said service requestor and said service provider to each other;
means for searching for wide potential matches from adjacent and next-to-adjacent and next-to-next-to-adjacent cells based on non-real-time data;
means for re-polling of said mobile operators for real-time locations; and
means for performing a final narrow match on the re-polled location information.

19. The system in claim 16, further comprising means for simultaneously or sequentially connecting multiple service providers to said service requestor and allowing the first service provider to answer to connect with said service requestor.

20. The system in claim 16, further comprising means for establishing a voice connection upon a successful match between said service requestor and said service provider.
